(19) United States
(12) Patent Application Publication
(10) Pub. No.: US 2025/0313202 A1
(43) Pub. Date: Oct. 9, 2025

(54) SYSTEM AND METHOD FOR LONGITUDINAL ACCELERATION PLANNING

(71) Applicant: Torc Robotics, Inc., Blacksburg, VA (US)

(72) Inventors: Akshay Pai Raikar, Blacksburg, VA (US); Joseph R. Fox-Rabinovitz, Blacksburg, VA (US)

(21) Appl. No.: 18/629,656

(22) Filed: Apr. 8, 2024

(51) Int. Cl. B60W 30/16; B60W 30/14; G01C 21/28

(52) U.S. Cl. CPC B60W 30/16; B60W 30/143; G01C 21/28; B60W 2420/408; B60W 2554/406; B60W 2554/804

(57) ABSTRACT

A system for longitudinal acceleration planning is disclosed. The system includes a plurality of sensors including at least one of a light detection and ranging (LiDAR) sensor or a radio detection and ranging (RADAR) sensor, at least one memory configured to store instructions, and at least one processor configured to execute the stored instructions to: (i) receive sensor data, from the plurality of sensors, representing respective acceleration and location coordinates of a plurality of vehicles travelling in a direction of travel of a vehicle associated with the system; (ii) based upon the received sensor data, determine a feed-forward parameter corresponding to a traffic wave representing the respective acceleration and location coordinates of the plurality of vehicles; and (iii) based upon the determined feed-forward parameter, determine and apply a required acceleration of the vehicle to maintain a distance and a pace with the plurality of vehicles.

### TECHNICAL FIELD

The field of the disclosure relates to behaviors and planning and, in particular, to a method and a system for behaviors and planning for longitudinal acceleration of a vehicle using traffic waves.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

One typical problem of behaviors and planning control for an autonomous vehicle is to keep up with traffic, for example, when the vehicles are frequently stopping and moving in a scenario like vehicles stopping and moving at a traffic light. Similarly, planning for slowing down for stopping is another problem for the autonomous vehicle. However, these problems described herein for behaviors and planning of the autonomous vehicle are not specific to the autonomous vehicle only but may also be a concern for a non-autonomous vehicle or a semi-autonomous vehicle. Accordingly, there exists a need of a system and a method to maintain proper road position in surrounding traffic.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a system for longitudinal acceleration planning is disclosed. The system includes a plurality of sensors including at least one of a light detection and ranging (LiDAR) sensor or a radio detection and ranging (RADAR) sensor, at least one memory configured to store instructions, and at least one processor configured to execute the stored instructions to: (i) receive sensor data, from the plurality of sensors, representing respective acceleration and location coordinates of a plurality of vehicles travelling in a direction of travel of a vehicle associated with the system; (ii) based upon the received sensor data, determine a feed-forward parameter corresponding to a traffic wave representing the respective acceleration and location coordinates of the plurality of vehicles; and (iii) based upon the determined feed-forward parameter, determine and apply a required acceleration of the vehicle to maintain a distance and a pace with the plurality of vehicles.

In another aspect, a computer-implemented method performed by at least one processor of a longitudinal acceleration planning system is disclosed. The method includes (i) receiving sensor data corresponding to respective acceleration and location coordinates of a plurality of vehicles travelling in a direction of travel of a vehicle associated with the longitudinal acceleration planning system; (ii) based upon the received sensor data, determining a feed-forward parameter corresponding to a traffic wave representing the respective acceleration and location coordinates of the plurality of vehicles; and (iii) based upon the determined feed-forward parameter, determining and applying a required acceleration of the vehicle to maintain a distance and a pace with the plurality of vehicles.

In yet another aspect, a vehicle of a plurality of vehicles including a plurality of sensors including at least one of a light detection and ranging (LiDAR) sensor or a radio detection and ranging (RADAR) sensor, at least one memory configured to store instructions, a control element, and at least one processor is disclosed. The at least one processors is configured to execute the stored instructions to receive sensor data, from the plurality of sensors, representing to respective acceleration and location coordinates of other vehicles of the plurality of vehicles in a direction of travel of the vehicle, and based upon the received sensor data, determine a feed-forward parameter corresponding to a traffic wave representing the respective acceleration and location coordinates of the other vehicles of the plurality of vehicles. The control element is configured to determine and apply a required acceleration of the vehicle, based upon the determined feed-forward parameter, to maintain a distance and a pace with the other vehicles of the plurality of vehicles.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck;

FIG. 2 is a block diagram of the autonomous truck shown in FIG. 1;

FIG. 3 is a block diagram of an example computing system;

FIGS. 4A-4D illustrate exemplary traffic situations and corresponding traffic wave representing accelerations or velocities of a plurality of vehicles on the road;

FIG. 5 is a block diagram of an example computing device; and

FIG. 6 is a flow-chart of method operations performed by a longitudinal acceleration planning system.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NITSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Generally, vehicles in traffic need to come to a full stop at a traffic light, a stop sign, or when there is an incident such as an accident, etc. As the vehicles start moving again, velocities of vehicles may vary depending on positions of the vehicles on the road with respect to the traffic light, the stop sign, or the incident causing slowdown or stopping of the vehicles. Movement of vehicles in such scenario may correspond to a wave of increasing velocity moving backwards along the road towards a vehicle, for example, an autonomous vehicle. By way of a non-limiting example, the wave of velocities of vehicles may be represented using a logistic function, also referenced herein as a sigmoid function or a single-front function.

In some embodiments, the logistic function may be represented as

$$\frac{{v}_{max}}{I + {e}^{k ( x - xo )}}$$

wherein vₘₐₓ, k, and xo vary with time t. Further, vₘₐₓ corresponds with the maximum velocity that is fairly stable since it is generally bounded by the speed limit except for some outliers, k corresponds with the steepness of the sigmoid or the wave of velocities, and xo corresponds with an inflection point in the wave corresponding to the point of maximum acceleration. By way of an example, the point of maximum acceleration may be the location of the peak of the curve representing the acceleration and the position of vehicles over time. The steepness of the sigmoid may fluctuate depending on the acceleration profiles and response times of different drivers, and, therefore, the steepness may be averaged over time. Further, vₘₐₓ, k, and xo parameters are parameters of a Frenet Frame that is oriented, for example, along the roadway for the longitudinal acceleration planning of a vehicle.

In some embodiments, time-based filters may be applied to vₘₐₓ, k, and xo parameters. By way of a non-limiting example, a low-pass filter, a least mean squares filter, an Extended Kalman Filter, etc. may be applied to all three parameters simultaneously at each measurement (or time step). By estimating the velocity and width of the wave, a feed-forward parameter value may be determined and provided to a controller or behaviors and planning control. Additionally, or alternatively, any number of deterministic or probabilistic outlier rejection techniques such as, least squares, 3-sigma, random sample consensus (RANSAC), etc., may be used for outlier rejections due to drivers not moving at the same pace with normal traffic because of slow reflexes, lack of attention or any other problems.

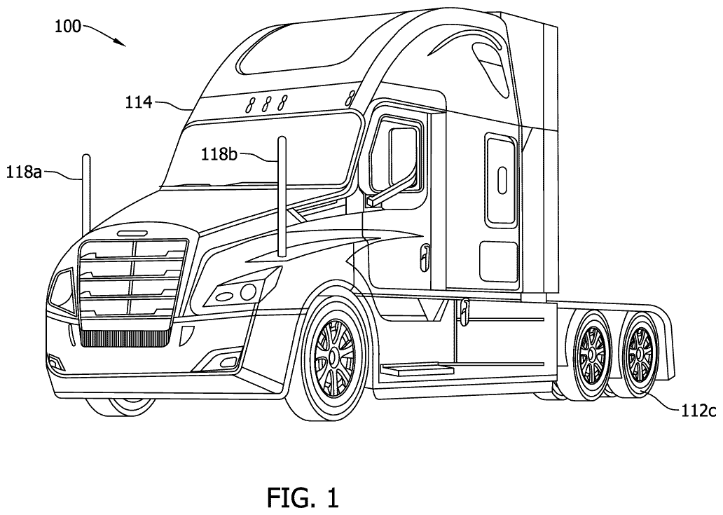

Various embodiments in the present disclosure are described with reference to FIGS. 1-4 below. Further, even though the embodiments are described for technologies used in autonomous vehicles, the embodiments described herein do not limit their scope to autonomous vehicles only and may be embodied in non-autonomous vehicles or semi-autonomous vehicles as well.

FIG. 1 illustrates a vehicle 100, such as a truck that may be conventionally connected to a single or tandem trailer to transport the trailers (not shown) to a desired location. The vehicle 100 includes a cabin 114 that can be supported by, and steered in the required direction, by front wheels 112a, 112b, and rear wheels 112c that are partially shown in FIG. 1. Wheels 112a, 112b are positioned by a steering system that includes a steering wheel and a steering column (not shown in FIG. 1). The steering wheel and the steering column may be located in the interior of cabin 114.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors. A plurality of sensors including one or more light detection and ranging (LiDAR) sensors, one or more radio detection and ranging (RADAR) sensors, one or more infrared sensors, one or more ultrasound sensors, or one or more image sensors, etc. The plurality of sensors may determine accelerations or velocities of a plurality of vehicles in the traffic surrounding the vehicle 100. In particular, the plurality of sensors may be positioned on the vehicle 100 to determined accelerations or velocities of the plurality of vehicles in the same traffic lane in which the vehicle 100 is travelling, or ahead of the vehicle 100.

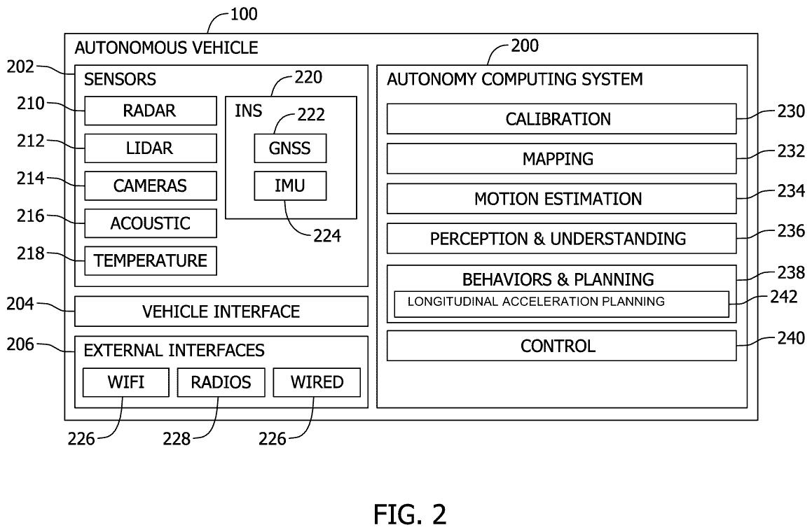

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, RADAR sensors 210, LiDAR sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100, and in particular longitudinal acceleration control planning, as described herein.

Cameras 214 are configured to capture images of the environment surrounding autonomous vehicle 100 in any aspect or field of view (FOV). The FOV can have any angle or aspect such that, at least, images of the areas ahead of autonomous vehicle 100 may be captured. LiDAR sensors 212 generally include a laser generator and a detector that send and receive a LiDAR signal such that LiDAR point clouds (or “LiDAR images”), at least, of the areas ahead of autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be used in combination to determine conditions (e.g., locations of other objects, and accelerations or velocities of other objects) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motion characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module (also referenced herein as a control element or a controller) 240, and a longitudinal acceleration planning module 242. The longitudinal acceleration planning module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The longitudinal acceleration planning module 242 may help maintain proper lane position or pace of the autonomous vehicle 100 in all conditions. The longitudinal acceleration planning module 242 receives, for example, accelerations or velocities, and coordinates of various objects or vehicles ahead of the autonomous vehicle 100 from perception and understanding module 236 (or sensors 202).

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

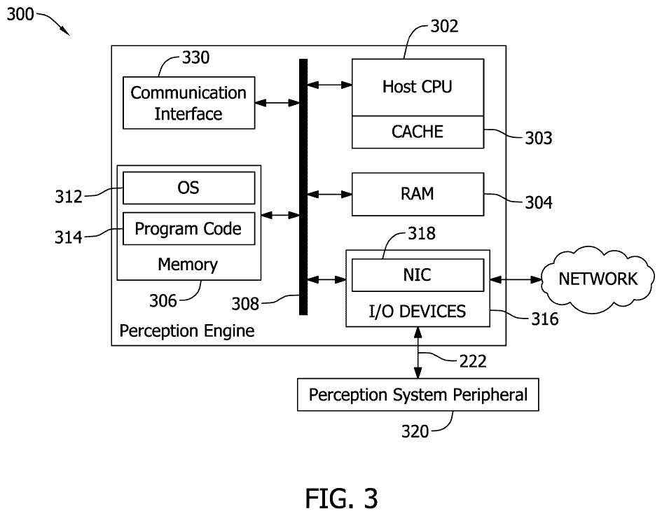

FIG. 3 is a block diagram of an example computing system 300, such as the autonomy computing system 200 shown in FIG. 2, configured for sensing an environment of an autonomous vehicle. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more section of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

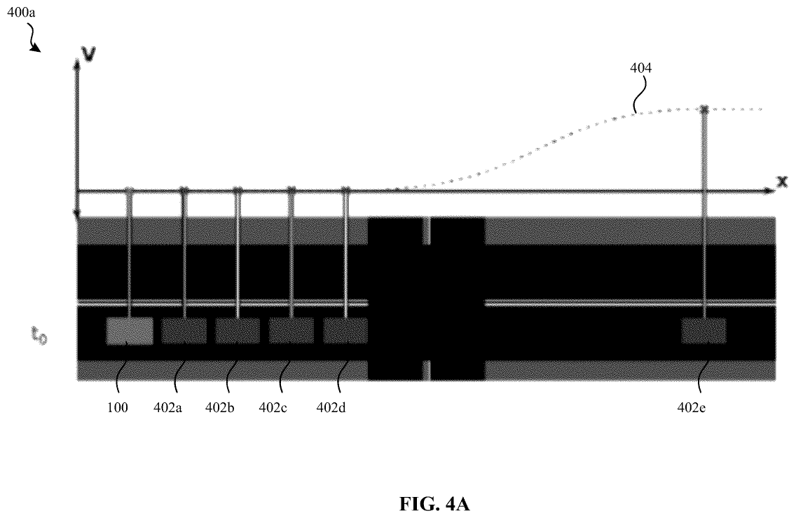

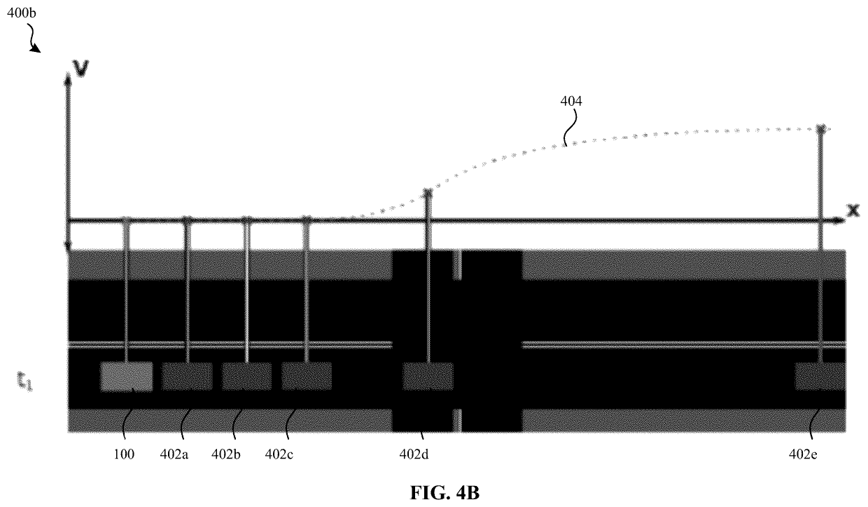

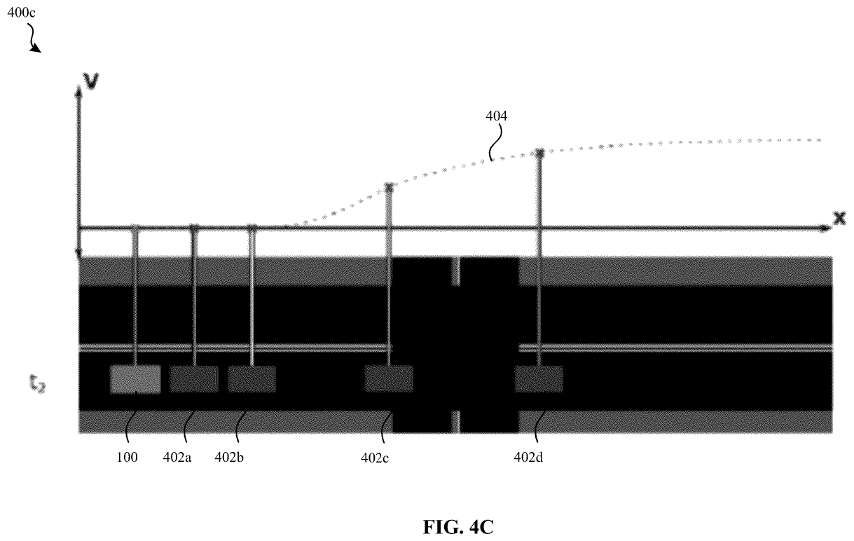

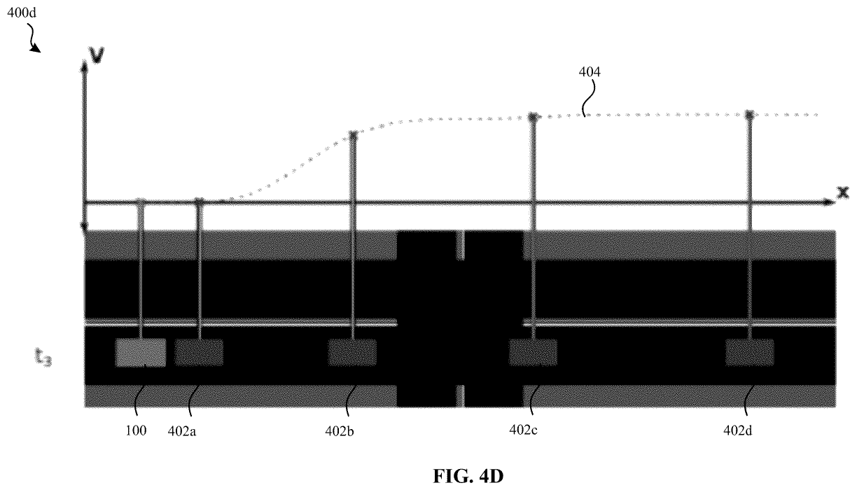

FIGS. 4A-4D illustrate exemplary traffic situations and corresponding traffic wave representing accelerations or velocities of a plurality of vehicles on the road. As shown in an illustration 400a of FIG. 4A, at time to, the anonymous vehicle 100 may have a plurality of vehicles 402a-402e ahead of the autonomous vehicle 100. Vehicles 402a-402d are fully stopped at cross-roads (e.g., a stop sign, or a traffic light), and vehicle 402e may be moving. Accordingly, a velocity or acceleration graph 404 may show accelerations or velocities of the autonomous vehicle 100 and vehicles 402a-402e as along the vertical axis and corresponding positions of the autonomous vehicle 100 and vehicles 402a-402e along the horizontal axis. The acceleration or velocity for each of the autonomous vehicle 100 and vehicles 402a-402d is zero at time t₀.

As shown in an illustration 400b of FIG. 4B, at time t₁, vehicle 402d also started moving, and therefore acceleration or velocity of vehicle 402d and its corresponding location on the graph 404 may be, for example, as shown in FIG. 4B. Further, a wave of increasing velocity or acceleration represented as a curve may be seen as moving backwards along the road towards the autonomous vehicle 100.

As shown in an illustration 400c of FIG. 4C, at time t₂, vehicles 402b-402c are moving, and their respective acceleration or velocity and corresponding locations on the graph 404 may be, for example, as shown in FIG. 4C. A wave of increasing velocity or acceleration represented as a curve may be seen as further moving backwards along the road towards the autonomous vehicle 100.

As shown in an illustration 400d of FIG. 4D, at time t₃, vehicles 402b-402d are moving, and their respective acceleration or velocity and corresponding locations on the graph 404 may be, for example, as shown in FIG. 4D. A wave of increasing velocity or acceleration represented as a curve may be seen as further moving backwards along the road towards the autonomous vehicle 100.

The wave of velocities or accelerations corresponding to the plurality of vehicles 402a-402e based upon acceleration or velocity data collected by sensors 202, e.g., LiDAR sensors 212 or RADAR sensors 210, may be represented using the logistic function

$$\frac{{v}_{max}}{I + {e}^{k ( x - xo )}}$$

wherein vₘₐₓ, k, and xo vary with time t. As described herein, vₘₐₓ corresponds with the maximum velocity that is fairly stable since it is generally bounded by the speed limit except some outliers, k corresponds with the steepness of the sigmoid or the wave of velocities, and xo corresponds with an inflection point in the wave corresponding to the point of maximum acceleration. By way of an example, the point of maximum acceleration may be the location of the peak of the curve representing the acceleration and the position of vehicles over time. The steepness of the sigmoid may fluctuate depending on the acceleration profiles and response times of different drivers, and, therefore, the steepness may be averaged over time. Further, vₘₐₓ, k, and xo are parameters of a Frenet Frame that is oriented, for example, along the roadway for the longitudinal acceleration planning of a vehicle.

In some embodiments, time-based filters such as, a low-pass filter, a least mean squares filter, an Extended Kalman Filter, etc., may be applied to vₘₐₓ, k, and xo parameters at each measurement, or time steps to, t₁, t₂, and t₃. By way of a non-limiting example, time steps to, t₁, t₂, and t₃ may be periodic time intervals. By estimating the velocity and width of the wave, a feed-forward parameter value may be determined using the equation described herein. The feed-forward parameter value may be used by a controller or behaviors and planning control to estimate acceleration and time when the vehicles ahead of the autonomous vehicle 100 will start moving. The controller or behaviors and planning control may then determine a required acceleration and time for the autonomous vehicle 100 to move at the same pace with vehicles 402a-402e.

Additionally, or alternatively, any number of deterministic or probabilistic outlier rejection techniques such as, least squares, 3-sigma, RANSAC, etc., may be used for outlier rejections due to drivers not moving at the same pace with normal traffic because of slow reflexes, lack of attention or any other problems. While the wave in the graph 404 represents a scenario in which vehicles starts moving or getting into speed after being stopped, the wave corresponding to vehicles slowing may be used to determine deceleration and time for the autonomous vehicle 100 to slow down.

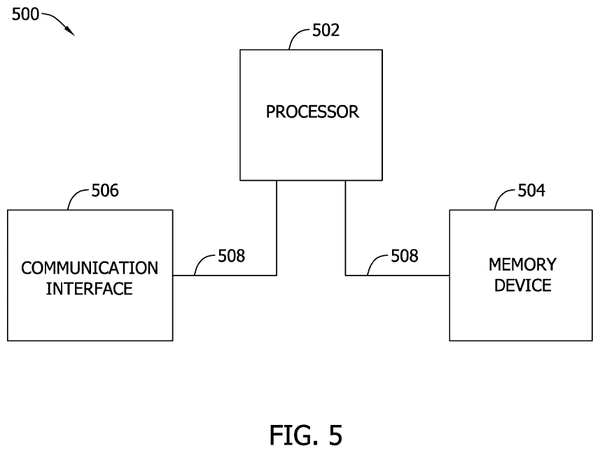

FIG. 5 is a block diagram of an example computing device 500. Computing device 500 includes a processor 502 and a memory device 504. The processor 502 is coupled to the memory device 504 via a system bus 508. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 504 includes one or more devices that enable information, such as executable instructions or other data (e.g., sensor data), to be stored and retrieved. Moreover, the memory device 504 includes one or more computer readable media, such as, without limitation, dynamic random access memory (DRAM), static random access memory (SRAM), a solid state disk, or a hard disk. In the example embodiment, the memory device 504 stores, without limitation, application source code, application object code, configuration data, additional input events, application states, assertion statements, validation results, or any other type of data. The computing device 500, in the example embodiment, may also include a communication interface 506 that is coupled to the processor 502 via system bus 508. Moreover, the communication interface 506 is communicatively coupled to data acquisition devices.

In the example embodiment, processor 502 may be programmed by encoding an operation using one or more executable instructions and providing the executable instructions in the memory device 504. In the example embodiment, the processor 502 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

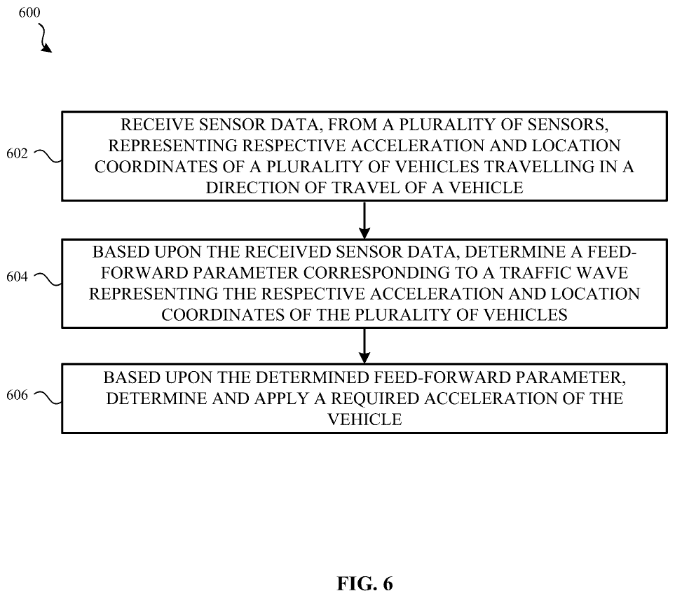

FIG. 6 is an example flow-chart 600 of method operations performed by a longitudinal acceleration planning system, such as a computing device 500 shown in FIG. 5 or a computing system 300 shown in FIG. 3. The method operations shown in the flow-chart 600 may be performed by the longitudinal acceleration planning system or a perception system of a vehicle. The method operations may include receiving 602 sensor data from a plurality of sensors. The plurality of sensors may include at least one of a light detection and ranging (LiDAR) sensor or a radio detection and ranging (RADAR) sensor. The sensor data may represent respective acceleration and location coordinates of a plurality of vehicles travelling in a direction of travel of a vehicle associated with the longitudinal acceleration planning system. By way of a non-limiting example, the sensor data may be received periodically at a preconfigured time interval, such as every 2 seconds, 5 seconds, etc.

The method operations may include determining 604 a feed-forward parameter corresponding to a traffic wave representing the respective acceleration and location coordinates of the plurality of vehicles. The feed-forward parameter may be determined 604 based upon the received sensor data. The traffic wave may be represented as a sigmoid function

$$\frac{{v}_{max}}{I + {e}^{k ( x - xo )}} ,$$

wherein vₘₐₓ corresponds with a maximum velocity, k corresponds with a steepness of a curve of the traffic wave, and xo corresponds with an inflection point in the traffic wave corresponding to a point of maximum acceleration. Further, as described herein, at least one of a low-pass filter, a least mean squares filter, or an extended Kalman Filter may be applied to the vₘₐₓ, k, and xo parameters, and a deterministic outlier rejection technique or a probabilistic outlier rejection technique may be applied to reject outliers.

The method operations may include determining and applying 606 a required acceleration of the vehicle to maintain a distance and a pace with the plurality of vehicles. The required acceleration may be determined based upon the determined feed-forward parameter and applied by the control element 240 shown in FIG. 2. By way of a non-limiting example, the feed-forward parameter and the required acceleration of the vehicle may be determined for a preconfigured time period after the vehicle is stopped. Additionally, or alternatively, the feed-forward parameter and the required acceleration of the vehicle may be determined until the vehicle attains a speed within a specific threshold limit of average speed of the plurality of vehicles. The average speed of the plurality of vehicles may be determined based on the received sensor data.

In some embodiments, based upon the received sensor data, a second feed-forward parameter corresponding to another traffic wave representing respective deceleration and corresponding location coordinates of the plurality of vehicles may be determined. Based on the second feed-forward parameter, a required deceleration of the vehicle to slow down and stop at a predetermined distance from at least one vehicle of the plurality of vehicles may be determined to apply by the control element 240.

An example technical effect of the methods, systems, and apparatus described herein includes at least one of: (a) increased safety of operations by an autonomous vehicle; and (b) maintaining proper road position and pace of the autonomous vehicle with other vehicles on the road in the traffic.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for longitudinal acceleration planning, the system comprising:
a plurality of sensors including at least one of a light detection and ranging (LiDAR) sensor or a radio detection and ranging (RADAR) sensor;
at least one memory configured to store instructions; and
at least one processor configured to execute the stored instructions to:
receive sensor data, from the plurality of sensors, representing respective acceleration and location coordinates of a plurality of vehicles travelling in a direction of travel of a vehicle associated with the system;
based upon the received sensor data, determine a feed-forward parameter corresponding to a traffic wave representing the respective acceleration and location coordinates of the plurality of vehicles; and
based upon the determined feed-forward parameter, determine and apply a required acceleration of the vehicle to maintain a distance and a pace with the plurality of vehicles.

2. The system of claim 1, wherein the sensor data is received periodically at a preconfigured time interval.

3. The system of claim 1, wherein the traffic wave is represented as a sigmoid function
$$\frac{{v}_{max}}{I + {e}^{k ( x - xo )}} ,$$
wherein vₘₐₓ corresponds with a maximum velocity, k corresponds with a steepness of a curve of the traffic wave, and xo corresponds with an inflection point in the traffic wave corresponding to a point of maximum acceleration.

4. The system of claim 3, wherein the at least one processor is further configured to apply at least one of a low-pass filter, a least mean squares filter, or an extended Kalman Filter to the vₘₐₓ, k, and xo.

5. The system of claim 3, wherein the at least one processor is further configured to reject outliers using a deterministic outlier rejection technique or a probabilistic outlier rejection technique.

6. The system of claim 1, wherein the feed-forward parameter and the required acceleration of the vehicle are determined for a preconfigured time period after the vehicle is stopped.

7. The system of claim 1, wherein the feed-forward parameter and the required acceleration of the vehicle are determined until the vehicle attains a speed within a specific threshold limit of average speed of the plurality of vehicles.

8. The system of claim 1, wherein the at least one processor is further configured to:
based upon the received sensor data, determine a second feed-forward parameter corresponding to another traffic wave representing respective deceleration and corresponding location coordinates of the plurality of vehicles; and
based upon the determined second feed-forward parameter, determine and apply a required deceleration of the vehicle to slow down and stop at a predetermined distance from at least one vehicle of the plurality of vehicles.

9. A computer-implemented method performed by at least one processor of a longitudinal acceleration planning system, the method comprising:
receiving sensor data corresponding to respective acceleration and location coordinates of a plurality of vehicles travelling in a direction of travel of a vehicle associated with the longitudinal acceleration planning system;
based upon the received sensor data, determining a feed-forward parameter corresponding to a traffic wave representing the respective acceleration and location coordinates of the plurality of vehicles; and
based upon the determined feed-forward parameter, determining and applying a required acceleration of the vehicle to maintain a distance and a pace with the plurality of vehicles.

10. The computer-implemented method of claim 9, wherein the sensor data is received periodically at a preconfigured time interval from a plurality of sensors including at least one of a light detection and ranging (LiDAR) sensor or a radio detection and ranging (RADAR) sensor.

11. The computer-implemented method of claim 9, wherein the traffic wave is represented as a sigmoid function
$$\frac{{v}_{max}}{I + {e}^{k ( x - xo )}} ,$$
wherein vₘₐₓ corresponds with a maximum velocity, k corresponds with a steepness of a curve of the traffic wave, and xo corresponds with an inflection point in the traffic wave corresponding to a point of maximum acceleration.

12. The computer-implemented method of claim 11, further comprising applying at least one of a low-pass filter, a least mean squares filter, or an extended Kalman Filter to the vₘₐₓ, k, and xo.

13. The computer-implemented method of claim 11, further comprising rejecting outliers using a deterministic outlier rejection technique or a probabilistic outlier rejection technique.

14. The computer-implemented method of claim 9, further comprising determining the feed-forward parameter and the required acceleration of the vehicle for a preconfigured time period after the vehicle is stopped.

15. The computer-implemented method of claim 9, further comprising determining the feed-forward parameter and the required acceleration of the vehicle until the vehicle attains a speed within a specific threshold limit of average speed of the plurality of vehicles.

16. The computer-implemented method of claim 9, further comprising:
based upon the received sensor data, determining a second feed-forward parameter corresponding to another traffic wave representing respective deceleration and corresponding location coordinates of the plurality of vehicles; and
based upon the determined second feed-forward parameter, determining and applying a required deceleration of the vehicle to slow down and stop at a predetermined distance from at least one vehicle of the plurality of vehicles.

17. A vehicle of a plurality of vehicles, the vehicle comprising:
a plurality of sensors including at least one of a light detection and ranging (LiDAR) sensor or a radio detection and ranging (RADAR) sensor;
at least one memory configured to store instructions; and
at least one processor configured to execute the stored instructions to:
receive sensor data, from the plurality of sensors, representing to respective acceleration and location coordinates of other vehicles of the plurality of vehicles in a direction of travel of the vehicle; and
based upon the received sensor data, determine a feed-forward parameter corresponding to a traffic wave representing the respective acceleration and location coordinates of the other vehicles of the plurality of vehicles; and
a control element configured to determine and apply a required acceleration of the vehicle, based upon the determined feed-forward parameter, to maintain a distance and a pace with the other vehicles of the plurality of vehicles.

18. The vehicle of claim 17, wherein the traffic wave is represented as a sigmoid function
$$\frac{{v}_{max}}{I + {e}^{k ( x - xo )}} ,$$
wherein vₘₐₓ corresponds with a maximum velocity, k corresponds with a steepness of a curve of the traffic wave, and xo corresponds with an inflection point in the traffic wave corresponding to a point of maximum acceleration, and
wherein the at least one processor is further configured to:
apply at least one of a low-pass filter, a least mean squares filter, or an extended Kalman Filter to the vₘₐₓ, k, and xo, wherein vₘₐₓ corresponds with a maximum velocity, k corresponds with a steepness of a curve of the traffic wave, and xo corresponds with an inflection point in the traffic wave corresponding to a point of maximum acceleration; and
reject outliers using a deterministic outlier rejection technique or a probabilistic outlier rejection technique.

19. The vehicle of claim 17, wherein the feed-forward parameter and the required acceleration are determined for a preconfigured time period after the vehicle is stopped, or until the vehicle attains a speed within a specific threshold limit of average speed of the other vehicles of the plurality of vehicles.

20. The vehicle of claim 17, wherein the at least one processor is further configured to, based upon the received sensor data, determine a second feed-forward parameter corresponding to another traffic wave representing respective deceleration and corresponding location coordinates of the other vehicles of the plurality of vehicles; and
wherein the control element is further configured to, based upon the determined second feed-forward parameter, determine and apply a required deceleration of the vehicle to slow down and stop at a predetermined distance from at least one vehicle of the other vehicles of the plurality of vehicles.
